(19) United States
(12) Patent Application Publication
(10) Pub. No.: US 2021/0357813 A1
(43) Pub. Date: Nov. 18, 2021

(54) DEVICE AND COMPUTER-IMPLEMENTED METHOD FOR MACHINE LEARNING

(71) Applicant: Robert Bosch GmbH, Stuttgart (DE)

(72) Inventors: Martin Schiegg, Korntal-Muenchingen (DE); Sebastian Gerwinn, Leonberg (DE)

(21) Appl. No.: 17/315,878

(22) Filed: May 10, 2021

(30) Foreign Application Priority Data
May 12, 2020 (DE) 102020205963.2

(51) Int. Cl. G06N 20/00; B25J 9/16; B60W 60/00

(52) U.S. Cl. CPC G06N 20/00; B60W 60/0011; B25J 9/161

(57) ABSTRACT

A device and a computer-implemented method for machine learning. A set of measurements of input variables of a system are provided. An optimization problem is defined as a function of the set of measurements of input variables and as a function of a unit sphere in a Hilbert space including a reproducing kernel. The unit sphere is defined as a function of the reproducing kernel. A solution the optimization problem is determined, which defines input data for a measurement at the system. A measurement of output data at the system is detected as a function of the input data. Pairs of training input data and training output data are determined as a function of the input data and the measurement of output data. A system model for the system is trained as a function of the pairs. The reproducing kernel is determined as a function of the system model.

### CROSS REFERENCE

The present application claims the benefit under 35 U.S.C. § 119 of German Patent No. DE 102020205963.2 filed May 12, 2020, which is expressly incorporated herein by reference in its entirety.

### BACKGROUND INFORMATION

One approach for machine learning uses a statistical experimental design in which a set of input points to be measured is determined from predefined input variables, and measurements are carried out at a system for this set of selected input points. As a function of the output data which are measured in the measurements, a system model is learned, using which output data that correspond as well as possible with a real behavior of the system are also determinable for input data other than the selected input data.

### SUMMARY

In the following description, the term input variable refers to a signal for a system which may be measured, for example, an rpm or a load of an engine. A measurement is a time series of values of an input variable. Multiple measurements of values of the input variable are referred to as a set of measurements of input variables. Multiple input variables may be provided. The term output variable refers to a signal for the system which may also be measured, for example, an emission of the engine. Multiple measurements of values of the output variable are referred to as a set of measurements of the output variable. In the exemplary system in accordance with the present invention, the output variable changes as a function of the input variable or as a function of the multiple input variables.

The term input data refers to one or multiple assignments of input variables with values. The term output data refers to one or multiple assignments of output variables with values. These values are either measured or selected arbitrarily. These values may be determined by an optimization, which may be applied in a second step to the system, associated output variables being able to be measured. The input data may thus be one time series or multiple time series of assignments of input variables. In one measurement, for example, a sequence of an rpm of an engine and a sequence of a load of the engine are combined. One set of measurements includes multiple sequences of the rpm and multiple sequences of the load, i.e., multiple measurements. An input point is defined by the assignments of the input variables. An input point may be defined by one measurement or by the set of measurements.

A computer-implemented method and a device according to example embodiments of the present invention may enable a particularly good system model to be learned particularly efficiently.

In accordance with an example embodiment of the present invention, the computer-implemented method for machine learning provides that a set of measurements of input variables of a system, which is in particular dynamic or static, is provided, an optimization problem being defined as a function of the set of measurements of input variables and as a function of a unit sphere in a Hilbert space including a reproducing kernel, the unit sphere being defined as a function of the reproducing kernel, a solution of the optimization problem being determined which defines input data for a measurement at the system, a measurement of output data at the system being detected as a function of the input data, pairs of training input data and training output data being determined as a function of the input data and the measurement of output data, a system model for the system being trained as a function of the pairs, and the reproducing kernel being determined as a function of the system model. Proceeding from measurements of input variables of the system, a design for input data is determined, using which measurements of output variables are to be carried out at the system, which define the output data. Training data for a training of the system model, which is defined, for example by a Gaussian process, are determined as pairs of the input data thus determined and the output data measured thereby at the system. The solution of the optimization problem supplies input data which occur in operation of the system with greater probability than other input data. In the training based thereon, the uncertainty that the system model has in relation to the system is reduced for these input data.

Preferably, a set union of training input data is determined as a function of the training input data and the input data. This enables all preceding training input data to be used in a training in iterations.

Preferably, a set union of training output data is determined as a function of the training output data and the measurement of output data. This enables all preceding training output data to be used in a training in iterations.

In accordance with an example embodiment of the present invention, the system model is preferably trained in iterations, in one iteration, in particular training exclusively being carried out using pairs of training input data and training output data from iterations preceding this iteration. The system model and the kernel are thus updated using new training data.

The training input data may be defined by a set of input data for the system. This enables an efficient training.

Preferably, the training input data are initialized by an empty set or using training input data, which are in particular selected randomly from a set of measurements of input variables. This enables a first iteration to be carried out using a defined state.

The training output data may be defined by a set of measurements of output data for the system. This enables an association in pairs with the set of input data.

In accordance with an example embodiment of the present invention, the training output data are preferably initialized by an empty set or using training output data, which are in particular selected randomly from a set of measurements of output variables. This enables a first iteration to be carried out using a defined state.

At least one of the input variables may represent a signal of a sensor. Sensor signals are detectable particularly well. An activation of the system using a corresponding sensor signal may thus be determined as a design for input data for a measurement to be carried out.

The signal is preferably a signal of a camera, of a radar sensor, of a LiDAR sensor, of an ultrasonic sensor, of a position sensor, of a motion sensor, of an exhaust gas sensor, or of an air mass sensor.

The measurement of output data may define an output variable of the system model which represents an activation variable, a sensor signal, or an operating state for a machine.

Preferably, an actuator of an in particular semi-autonomous vehicle or robot is activated as a function of the activation variable, of the sensor signal, and/or of the operating state.

A device for machine learning in accordance with an example embodiment of the present invention is designed to carry out the method.

Further advantageous specific embodiments of the present invention result from the following description and the figures.

### BRIEF DESCRIPTION OF THE DRAWINGS

FIG. 1 shows a schematic illustration of a system for machine learning, in accordance with an example embodiment of the present invention.

FIG. 2 shows steps in a method for machine learning, in accordance with an example embodiment of the present invention.

### DETAILED DESCRIPTION OF EXAMPLE EMBODIMENTS

In the following, an iterative active learning method, representative active learning, is described in which a plurality of input data points is selected iteratively from possible input data, the system is measured at these input data points to obtain output data points, which are used by a system model for learning an association of input data points with output data points. The described procedure includes knowledge about an input distribution, using which an efficiency of the learning method is improved. An optimum, i.e., a solution of the optimization problem, represents in each iteration the most informative input data points and output data points for reducing an uncertainty, which exists about an output of the system model in a relevant range of the possible input data for the system.

In the approach described in the following, in accordance with an example embodiment of the present invention, for representative active learning, after a measurement of output variables for an initial design of an experiment, a quality of the system model is efficiently improved, a batch of input data points and output data points being determined iteratively, which are difficult to predict using the instantaneous system model, on the one hand, and are representative for the estimated distribution of input data points, on the other hand.

The following method is based on a system model p(y|x) for a system y(x). Input data x₁, . . . , x_{d} for the system are characterized by a random variable X∈ [symbol] ^{d} having a distribution p^{x} and a density p(x). For random variable X, an output variable Y∈ [symbol] of system model p(y|x) is determined, which in the example characterizes scalar output data y of the system.

In a learning step t of a statistical experimental design, a design for a set of input data Dₓ^{t}∈R^{b×d} is defined as a set of input data x₁, . . . , x_{b}; xᵢ∈R^{d} for system y(x), for which the output variables are to be measured in the experiment. This means that in the experiment, measurements are to be carried out at the points defined by the set of input data x₁, . . . , x_{b}; xᵢ∈R^{d} from all possible points Dₓ^{t}∈R^{b×d} of system y(x), b being a number of planned measurement points and d being a dimensionality of the input variables. System model p(y|x) defines in learning step t, as a function of the set of input data Dₓ^{t}, a probability distribution regarding hypothetical measurements D_{y}^{t} of output data y(Dₓ^{t}), which may be measured in the experiment.

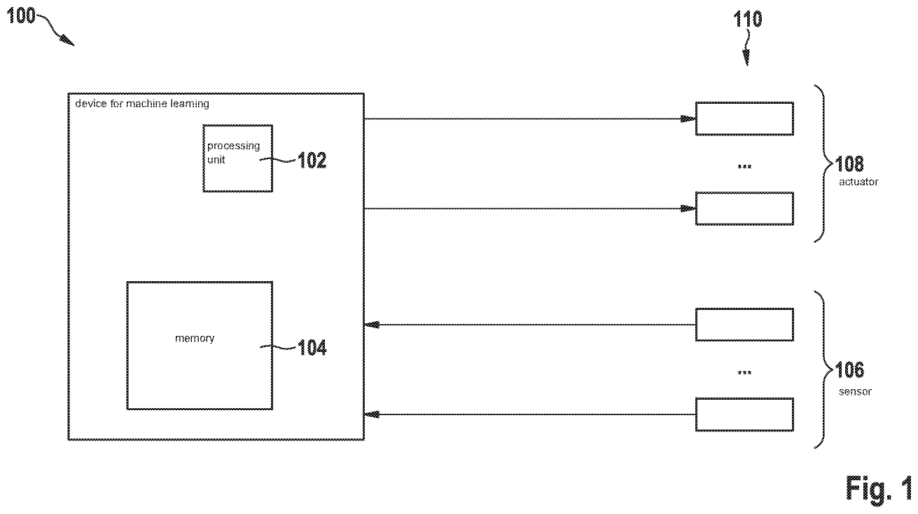

FIG. 1 schematically shows a device 100 for machine learning in accordance with an example embodiment of the present invention. Device 100 includes at least one processing unit 102 and at least one memory 104. Device 100 is designed, in the example, to detect measurements of a signal of at least one sensor 106. Device 100 is designed, in the example, to output an activation variable for at least one actuator 108. The at least one actuator 108 may be designed, for example, to activate an in particular semi-autonomous vehicle or a robot.

Sensor 106 may be a camera, a LiDAR sensor, an ultrasonic sensor, a position sensor, a motion sensor, an exhaust gas sensor, or an air mass sensor.

In the example, random variable X∈ [symbol] ^{d} represents at least one signal of a sensor. The signal may be a signal of the camera, of the radar sensor, of the LiDAR sensor, of the ultrasonic sensor, of the position sensor, of the motion sensor, of the exhaust gas sensor, or of the air mass sensor.

Output variable Y may represent an activation variable, a sensor signal, or an operating state for a machine 110.

For example, at least one actuator 108 is activated as a function of the activation variable, of the sensor signal, and/or of the operating state.

In the experiment, a set of measurements of input variables Xₚ of the system, for example a signal for each sensor which is defined by the set of N input data x₁, . . . , x_{N}; xᵢ∈R^{d} for system y(x), are measured. In the experiment, for at least a part of input variables Xₚ, output data y are measured in the example, which are selected for this purpose in the experiment. For example, in a respective iteration, respective input data Dₓ^{t} are predefined, for which output data y(Dₓ^{t}) are to be measured.

Input data Dₓ^{t} may be determined as a function of the set of measurements of input variables Xₚ as input data Dₓ^{t}⊂Xₚ. This means that input data Dₓ^{t} to be measured are selected from the measurement of input variables Xₚ. However, this restrictive condition is not absolutely necessary. Input data Dₓ^{t} may also be determined independently of the measurement of input variables Xₚ.

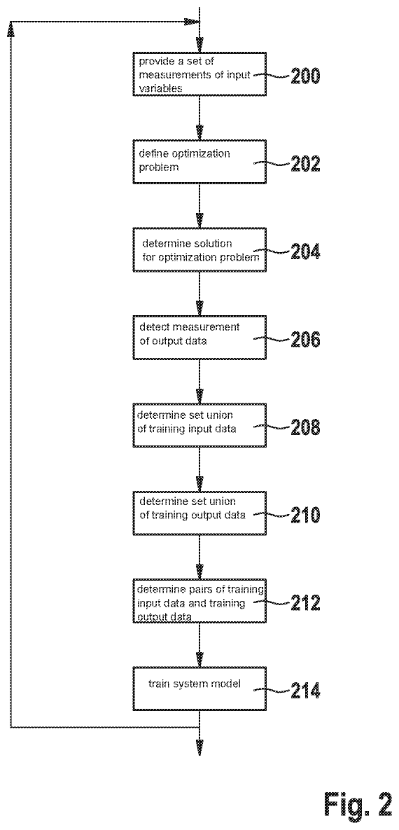

In the following, a computer-implemented method for machine learning in accordance with an example embodiment of the present invention is described with reference to FIG. 2.

In a step 200, a set of measurements of input variables Xₚ of system y(x) is provided, for example, from a database.

In a step 202, an optimization problem is defined

$${min}_{{D}_{x}^{t}} {MMD}^{2} [ {X}_{p} , {D}_{x}^{t} , {t}^{} ]$$

as a function of the set of measurements of input variables Xₚ and as a function of a unit sphere [symbol] ^{t} in a Hilbert space including reproducing kernel k_{pred}^{t}(.,.).

$$MMD = {( \frac{1}{{N}^{2}} {\sum }_{{x}_{i} , {x}_{j} ϵ {X}_{p}} {k}_{pred}^{t} ( {x}_{i} , {x}_{j} ) + \frac{1}{{b}^{2}} {\sum }_{{x}_{i} , {x}_{j} ϵ {D}_{x}^{t}} {k}_{pred}^{t} ( {x}_{i} , {x}_{j} ) - \frac{2}{Nb} {\sum }_{{x}_{i} ϵ {X}_{p} , {x}_{j} ϵ {D}_{x}^{t}} {k}_{pred}^{t} ( {x}_{i} , {x}_{j} ) )}^{\frac{1}{2}}$$

Unit sphere [symbol] ^{t} is determined as a function of reproducing kernel k_{pred}^{t}(⋅,⋅). Kernel k_{pred}^{t} is defined in the example as a function of system model p(y|x), system model p(y|x) modeling system y(x) in the example as a Gaussian process GP with a kernel k(⋅,⋅) and a mean value zero:

y|x˜GP(0, k(⋅,⋅))

k(x,x′) being able to be an arbitrary positive semi-definite core function, for example, the “squared exponential” kernel

$$k ( x , {x}^{′} ) = exp ( - \frac{{‖ x - {x}^{′} ‖}^{2}}{2 {l}^{2}} )$$

or the “rational quadratic” kernel:

$$k ( x , {x}^{′} ) = {( 1 + \frac{{‖ x - {x}^{′} ‖}^{2}}{2 α {l}^{2}} )}^{- α}$$

α and l being parameters of the kernel. These parameters represent hyperparameters of the Gaussian process and may be learned by maximizing the marginal likelihood of the Gaussian process with respect to the training data. This learning method is generally described in, for example, [1, Chapter 5].

[1] Carl Edward Rasmussen and Christopher K. I. Williams, Gaussian Processes for Machine Learning, The MIT Press, 2006. ISBN 0-262-18253-X.

For input data Dₓ^{t}, output data y(Dₓ^{t})={y(x)∀X∈Dₓ^{t}} are defined.

In the example, training input data X^{(t-1)} are defined from the set of measurements of input variables Xₚ.

For input data points x,x′, kernel k_{pred}^{t}(x,x′) in the example is a function of training input data X^{(t-1)} of system model p(y|x)=p(y|x,X^{(t-1)}, Y^{(t-1)}) defined as

k_{pred}^{t}(x,x′)=k(x,x′)−k(x,X^{(t-1)})k(X^{(t-1)},X^{(t-1)})⁻¹k(k(X^{(t-1)},x′)

k(x,X^{(t-1)}) being a vector which is determined by determining kernel k(⋅,⋅) at an input data point x with each input data point from X^{(t-1)} being determined, k(X^{(t-1)},X^{(t-1)}) being a matrix which is determined by determining kernel k(⋅,⋅) at all possible combinations of input data points from X^{(t-1)}, k(X^{(t-1)}, x′) being a vector which is determined by determining kernel k(⋅,⋅) at each input data point from X^{(t-1)} with an input data point x′.

If X^{(t-1)} is an empty set, kernel k_{pred}^{t}(x,x′) is defined as

k_{pred}^{t}(x,x′)=k(x,x′).

In a step 204, a solution of the optimization problem is determined. This solution defines input data Dₓ^{t} for a measurement at the system.

In a step 206, a measurement of output data y(Dₓ^{t}) at the system is detected as a function of input data Dₓ^{t}.

In a step 208, a set union of training input data X^{(t)} is determined as a function of training input data X^{(t-1)} and input data Dₓ^{t}. In the example, X^{(t)}=X^{(t-1)}∪Dₓ^{t} is determined.

In a step 210, a set union of training output data Y^{(t)} is determined as a function of training output data Y^{(t-1)} and the measurement of output data y(Dₓ^{t}). In the example, Y^{(t)}=Y^{(t-1)}∩y(Dₓ^{t}) is determined.

In a step 212, pairs (X^{(t)}, Y^{(t)}) of training input data X^{(t)} and training output data are determined Y^{(t)}.Training input data X^{(t)} are defined by a set of input data for the system. Training output data Y^{(t)} are defined by a set of measurements of output data y(X^{(t)}) for the system. This means, pairs (X^{(t)}, Y^{(t)}) of training input data X^{(t)} and training output data Y^{(t)} are determined as a function of input data X^{(t)} and the measurement of output data y(X^{(t)}).

In a step 214, system model p(y|x,X^{(t)}, Y^{(t)}) for the system is trained as a function of pairs (X^{(t)},Y^{(t)}).

In the example, in step 214, kernel k_{pred}^{t+1}(x,x′) is also determined for a next iteration:

k_{pred}^{t+1}(x,x′)=k(x,x′)−k(x,X^{(t)})k(X^{(t)},X^{(t)})

In the example, reproducing kernel k_{pred}^{t+1}(x,x′) for a following iteration t+1 is determined as a function of system model p(y|x,X(^{t)},Y^{(t)}) of iteration t. This means the reproducing kernel is determined as a function of the system model.

The system model trained on X^{(t)}, Y^{(t)}, thus p(y|x,X^{(t)},Y^{(t)}), is a Gaussian process, GP, the covariance function of which is k_{pred}^{t+1}(x,x′).

After the conditioning of the GP on data, the posterior GP reads as follows:

y|x,X^{(t)},Y^{(t)}˜GP(μ^{t+1}(x), k_{pred}^{t+1}(x,x′))

μ^{t+1}(x) being the mean value function of the GP, which is a function of X^{(t)},Y^{(t)}. This is not used further in the example.

System model p(y|x,X^{(t)},Y^{(t)}) is trained in the example in iterations, for example, by repeating the steps.

In one iteration, in the example, training is carried out exclusively using pairs (X^{(t)},Y^{(t)}) of training input data X^{(t)} and training output data Y^{(t)} from iterations preceding this iteration.

Training input data X⁽⁰⁾ may be initialized, for example, in step 200 by an empty set ∅ or using training input data X⁽⁰⁾, which are in particular selected randomly from a set of measurements of input variables Xₚ. Training output data Y⁽⁰⁾ may be initialized, for example, in step 200 by an empty set ∅ or by measurements of output variables on training input data X⁽⁰⁾ at the system.

Using system model p(y|x,X^{(T)},Y^{(T)}) thus trained, after T iterations, the activation variable, the sensor signal, and/or the operating state may be determined and an actuator of the in particular semi-autonomous vehicle or robot may be activated.

Instead of only planning a design once and measuring it, an iterative procedure is used by repeating the steps. System model p(y|x,X^{(T)},Y^{(T)}) thus trained is more accurate due to this method than upon the use of only one design, because training input data X^{(t)} and training output data Y^{(t)} are iteratively added to the training data, on which system model p(y|x,X^{(t)},Y^{(T)}) is inaccurate for the system and which are simultaneously also relevant. The relevance is measured as a function of a unit sphere [symbol] ^{t} in a Hilbert space with reproducing kernel k_{pred}^{t}(.,.) on the basis of a similarity of training input data X^{(t)} to the set of measurements of input variables Xₚ. By the solution of optimization problem MMD, in one iteration t training input data X^{(t)} best suitable for this are determined.

What is claimed is:

1. A computer-implemented method for machine learning, the method comprising the following steps:
providing a set of measurements of input variables of a system;
defining an optimization problem as a function of the set of measurements of input variables and as a function of a unit sphere in a Hilbert space including a reproducing kernel, the unit sphere being defined as a function of the reproducing kernel;
determining a solution of the optimization problem, which defines input data for a measurement at the system;
detecting a measurement of output data at the system as a function of the input data;
determining pairs of training input data and training output data as a function of the input data and the measurement of output data;
training a system model for the system as a function of the pairs; and
determining the reproducing kernel as a function of the system model.

2. The method as recited in claim 1, wherein a set union of training input data is determined as a function of the training input data and the input data.

3. The method as recited in claim 1, wherein a set union of training output data is determined as a function of the training output data and the measurement of output data.

4. The method as recited in claim 1, wherein the system model is trained in iterations, in each iteration, the training being carried out exclusively using pairs of the training input data and the training output data from the iteration and preceding iterations.

5. The method as recited claim 1, wherein the training input data are defined by a set of input data for the system.

6. The method as recited in claim 5, wherein the training input data are initialized by an empty set or using training input data, which are selected randomly from the set of measurements of input variables.

7. The method as recited in claim 1, wherein the training output data are defined by an empty set or by measurements of output variables on the training input data at the system.

8. The method as recited in claim 7, wherein the training output data are initialized by an empty set or using training output data which are selected randomly from a set of the measurements of output variables.

9. The method as recited in claim 1, wherein at least one of the input variables represents a signal of a sensor.

10. The method as recited in claim 9, wherein the signal is a signal of a camera, or of a radar sensor, or of a LiDAR sensor, or of an ultrasonic sensor, or of a position sensor, or of a motion sensor, or of an exhaust gas sensor, or of an air mass sensor.

11. The method as recited in claim 1, wherein the measurement of output data defines an output variable of the system model, which represents an activation variable, or a sensor signal, or an operating state for a machine.

12. The method as recited in claim 11, wherein an actuator of a semi-autonomous vehicle or robot is activated as a function of the activation variable, and/or of the sensor signal, and/or of the operating state.

13. A device for machine learning, the device configured to:
provide a set of measurements of input variables of a system;
define an optimization problem as a function of the set of measurements of input variables and as a function of a unit sphere in a Hilbert space including a reproducing kernel, the unit sphere being defined as a function of the reproducing kernel;
determine a solution of the optimization problem, which defines input data for a measurement at the system;
detect a measurement of output data at the system as a function of the input data;
determine pairs of training input data and training output data as a function of the input data and the measurement of output data;
train a system model for the system as a function of the pairs; and
determine the reproducing kernel as a function of the system model.

14. A non-transitory computer-readable medium on which is stored a computer program including computer-readable instructions for machine reading, the computer program, when executed by a computer, causing the computer to perform the following steps:
providing a set of measurements of input variables of a system;
defining an optimization problem as a function of the set of measurements of input variables and as a function of a unit sphere in a Hilbert space including a reproducing kernel, the unit sphere being defined as a function of the reproducing kernel;
determining a solution of the optimization problem, which defines input data for a measurement at the system;
detecting a measurement of output data at the system as a function of the input data;
determining pairs of training input data and training output data as a function of the input data and the measurement of output data;
training a system model for the system as a function of the pairs; and
determining the reproducing kernel as a function of the system model.
